(19) United States
(12) Patent Application Publication
(10) Pub. No.: US 2007/0104071 A1
(43) Pub. Date: May 10, 2007

(54) Optical pickup and disc drive apparatus

(75) Inventor: Yoshito Asoma, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/350,057

(22) Filed: Feb. 9, 2006

(30) Foreign Application Priority Data
Feb. 24, 2005 (JP) P2005-049562

(51) Int. Cl. G11B 7/135

(52) U.S. Cl. 369/112.05

(57) ABSTRACT

The present invention provides an optical pickup and a disc drive apparatusx` that make it possible to record information signals to and reproduce information signals from disc-shaped recording mediums of three different types by means of a single objective lens. The optical pickup includes a first light emitting element that emits a laser beam of a first wavelength, a second light emitting element that emits a laser beam of a second wavelength, a third light emitting element that emits a laser beam of a third wavelength, an objective lens that focuses the laser beams emitted from the first through third light emitting elements onto the signal recording surface of a disc-shaped recording medium, first and second diffracting sections arranged on the light paths of the first through third laser beams and adapted to diffract at least one of the laser beams of the first through third wavelengths, and a light receiving element that receives the return light reflected by the disc-shaped recording medium, the first diffracting section being adapted to substantially transmit one or two of the laser beams of the first through third wavelengths.

### CROSS REFERENCES TO RELATED APPLICATIONS

The present invention contains subject matter related to Japanese Patent Application JP 2005-049562 filed in the Japanese Patent Office on Feb. 24, 2005, the entire contents of which being incorporated herein by reference.

### BACKGROUND OF THE INVENTION

1. Field of the Invention

This invention relates to an optical pickup and a disc drive apparatus that make it possible to record information signals to and/or reproduce information signals from three different disc-shaped recording mediums by means of a single objective lens.

2. Description of the Related Art

Disc drive apparatus for recording information signals to and/or reproducing information signals from a disc-shaped recording medium are known. Such disc drive apparatus includes an optical pickup for irradiating a laser beam to the disc-shaped recording medium by way of an objective lens in order to record or reproduce information signals.

In recent years, disc-shaped recording mediums of various different types have been developed. The difference among the different types of recording medium lies in the recording density, the cover thickness and so on. There is a demand for disc-shaped recording mediums having a recording capacity greater than CDs (compact discs) that utilizes a laser beam with a wavelength of about 780 nm and DVDs (digital versatile discs) that utilizes a laser beam with a wavelength of about 660 nm. High recording density optical discs that utilizes a laser beam with a wavelength of about 405 nm have been attracting attention as disc-shaped recording mediums of the next generation that realize a much greater recording capacity.

Such high density recording optical discs include blue-ray discs that utilizes a laser beam with a wavelength of about 405 nm and AODs (advance optical discs) that also utilizes a laser beam with a wavelength of about 405 nm. HD-DVDs (high definition DVDs) that conform to a standard similar to the AOD Standard are also known. In the following description, HD-DVDs are included in AODs.

Disc drive apparatus that can be used to record information signals to and reproduce information signals from disc-shaped recording mediums of different types, using laser beams of different wavelengths, and are equipped with a plurality of objective lenses for disc-shaped recording mediums of different types are known (see, inter alia, Patent Document 1: Jpn. Pat. Appln. Laid-Open Publication No. 2001-110086).

The disc drive apparatus described in Patent Document 1 includes a biaxial actuator provided with a pair of objective lenses typically including one that corresponds to a disc-shaped recording medium to be used with a laser beam of a wavelength of about 405 nm and one that corresponds to a disc-shaped recording medium to be used with a laser beam of a wavelength of about 660 nm so that the laser beam of a wavelength of about 405 nm is converged on the disc-shaped recording medium of one of the two different types by one of the objective lenses, whereas the laser beam of a wavelength of about 660 nm is converged on the disc-shaped recording medium of the other type by the other objective lens for the purpose of recording information signals to or reproducing information signals from the disc-shaped recording mediums of the different types.

### SUMMARY OF THE INVENTION

However, known optical pickups including a plurality of objective lenses for recording information signals to and reproducing information signals from a plurality of disc-shaped recording mediums of different types includes a large number of components to make the disc drive apparatus dimensionally large and consequently raise the manufacturing cost.

Additionally, the weight of the movable part of the biaxial actuator is raised because of the plurality of objective lenses so that the responsiveness of the movable part can be degraded in the focusing control operation and the tracking control operation.

Therefore, it is desirable to provide an optical pickup and a disc drive apparatus that make it possible to record information signals to and reproduce information signals from disc-shaped recording mediums of three different types by means of a single objective lens.

According to the present invention, there is provided an optical pickup including: a first light emitting element that emits a laser beam of a first wavelength; a second light emitting element that emits a laser beam of a second wavelength; a third light emitting element that emits a laser beam of a third wavelength; an objective lens that focuses the laser beams emitted from the first through third light emitting elements onto the signal recording surface of a disc-shaped recording medium; first and second diffracting sections arranged on the light paths of the first through third laser beams and adapted to diffract at least one of the laser beams of the first through third wavelengths; and a light receiving element that receives the return light reflected by the disc-shaped recording medium; the first diffracting section being adapted to substantially transmit one or two of the laser beams of the first through third wavelengths.

According to the present invention, there is provided a disc drive apparatus including a disc table that receives a disc-shaped recording medium of one of different types and drives it to rotate, and an optical pickup that records information to or reproduces information from the disc-shaped recording medium received on the disc table, the optical pickup including: a first light emitting element that emits a laser beam of a first wavelength; a second light emitting element that emits a laser beam of a second wavelength; a third light emitting element that emits a laser beam of a third wavelength; an objective lens that focuses the laser beams emitted from the first through third light emitting elements onto the signal recording surface of a disc-shaped recording medium; first and second diffracting sections arranged on the light paths of the first through third laser beams and adapted to diffract at least one of the laser beams of the first through third wavelengths; and a light receiving element that receives the return light reflected by the disc-shaped recording medium; the first diffracting section being adapted to substantially transmit one or two of the laser beams of the first through third wavelengths.

Thus, in an optical pickup according to the invention, either the first or second diffracting section is adapted to substantially transmit one or two of the laser beams of the first through third wavelengths so that it is possible to record information signals to and reproduce information signals from disc-shaped recording mediums of three different types to be used with laser beams of different wavelengths by means of a single objective lens.

Additionally, an optical pickup according to the invention can record information signals to and reproduce information signals from disc-shaped recording mediums of three different types to be used with laser beams of different wavelengths by means of a single objective lens so that the optical pickup can be produced with a reduced number of components to make it possible to reduce both the dimensions of the optical pickup and the manufacturing cost. Furthermore, since an optical pickup according to the invention is adapted to use a single objective lens, the weight of the movable part of objective lens drive unit is reduced to secure an excellent responsiveness of the movable part in the focusing control operation and the tracking control operation.

Still additionally, a disc drive apparatus according to the invention includes a disc table that receives a disc-shaped recording medium of one of different types and drives it to rotate and an optical pickup that records information to or reproduces information from the disc-shaped recording medium received on the disc table and, in the optical pickup, either the first or second diffracting section is adapted to substantially transmit one or two of the laser beams of the first through third wavelengths so that it is possible to record information signals to and reproduce information signals from disc-shaped recording mediums of three different types to be used with laser beams of different wavelengths by means of a single objective lens.

Still additionally, a disc drive apparatus according to the invention can record information signals to and reproduce information signals from disc-shaped recording mediums of three different types to be used with laser beams of different wavelengths by means of a single objective lens so that the disc drive apparatus can be produced with a reduced number of components to make it possible to reduce both the dimensions of the disc drive apparatus and the manufacturing cost. Furthermore, since a disc drive apparatus according to the invention is adapted to use a single objective lens, the weight of the movable part of objective lens drive unit is reduced to secure an excellent responsiveness of the movable part in the focusing control operation and the tracking control operation.

### BRIEF DESCRIPTION OF THE DRAWINGS

FIG. 1 is a schematic perspective view of an embodiment of disc drive apparatus according to the invention;

FIG. 2 is a schematic illustration of the optical system of an embodiment of optical pickup according to the invention, showing the light paths thereof;

FIG. 3 is an enlarged schematic cross sectional view of part of the diffraction element of an embodiment of optical pickup according to the invention;

FIG. 4 is a graph illustrating the relationship between the wavelength and the refractive index of a material that can be used for forming the first diffracting section of the diffraction element of an embodiment of optical pickup according to the invention;

FIG. 5 is a schematic illustration of an objective lens and a diffraction. element that can be employed when an optical disc 100c of the third type is used as disc-shaped recording medium corresponding to a laser beam of the third wavelength

FIG. 6 is a schematic illustration of an objective lens and a diffraction element that can be employed when an optical disc 100d of the fourth type is used as disc-shaped recording medium corresponding to a laser beam of the third wavelength

FIG. 7 is a schematic illustration of another objective lens and another diffraction element that can be employed when an optical disc 100d of the fourth type is used as disc-shaped recording medium corresponding to a laser beam of the third wavelength;

FIG. 8 is a schematic illustration of the optical system of another embodiment of optical pickup according to the invention, showing the light paths thereof;

FIG. 9 is a schematic illustration of an embodiment of optical pickup according to the invention, where a polarizing hologram element is used for diffraction;

FIG. 10 is a schematic illustration of the optical system of still another embodiment of optical pickup according to the invention, showing the light paths thereof;

FIG. 11 is a schematic illustration of an embodiment of optical pickup according to the invention, where a stepped diffraction element is used for the optical pickup;

FIG. 12 is an enlarged schematic cross sectional view of the first diffracting section of an embodiment of optical pickup according to the invention, where a stepped diffraction element is used for the optical pickup;

FIG. 13 is a graph illustrating the diffraction efficiencies of laser beams of different wavelengths that varies as a function of the change in the groove depth of the first diffracting section of an embodiment of optical pickup according to the invention, where a stepped diffraction element is used for the optical pickup;

FIG. 14 is a graph illustrating the diffraction efficiencies of laser beams of different wavelengths that varies as a function of the change in the groove depth of the second diffracting section of an embodiment of optical pickup according to the invention, where a stepped diffraction element is used for the optical pickup; and

FIG. 15 is a schematic illustration of the diffracting section of an embodiment of optical pickup according to the invention, where an anti-stray-light section is provided.

### DETAILED DESCRIPTION OF THE PREFERRED EMBODIMENTS

Now, the present invention will be described in greater detail by referring to the accompanying drawings that illustrate preferred embodiments of optical pickup and disc drive apparatus according to the invention.

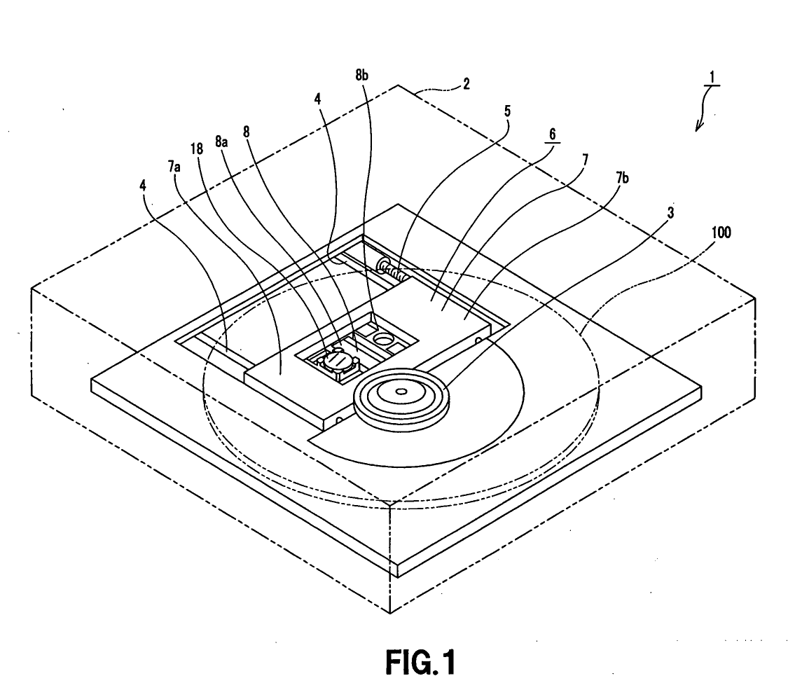

Referring firstly to FIG. 1 that illustrates an embodiment of disc drive apparatus 1 according to the invention, its members and mechanisms are arranged in an outer cabinet 2 having a disc insertion port (not shown).

A chassis (not shown) is arranged in the outer cabinet 2 and a disc table 3 is rigidly secured to the motor shaft of the spindle motor that is fitted to the chassis.

A pair of guide shafts 4 are fitted to the chassis and arranged in parallel with each other and a lead screw 5 that is driven to rotate by a feed motor (not shown) is supported by the chassis.

The optical pickup 6 includes a movable base 7, certain optical parts arranged on the movable base 7 and an objective lens drive unit 8 also arranged on the movable base 7. Bearing sections 7a, 7b arranged at opposite ends of the movable base 7 are supported by the respective guide shafts 4 so as to be able to slide along the latter. The objective lens drive unit 8 includes a movable section 8a and a fixed section 8b, of which the movable section 8a is movably supported by the fixed section 8b by way of a suspension (not shown). A nut member (not shown) arranged on the movable base 7 is engaged with the lead screw 5 so that, as the lead screw 5 is driven to rotate, the nut member is fed in the direction that corresponds to the sense of rotation of the lead screw 5 and the optical pickup 6 is driven to move in a radial direction of the disc-shaped recording medium 100 mounted on the disc table 3.

Disc-shaped recording mediums 100 that can be mounted on the disc table 3 for use include optical discs such as CDs (compact discs), DVDs (digital versatile discs), CD-Rs (recordable) that are write once type compact discs, DVD-Rs (recordable), CD-RWs (rewritable) that are rewritable type compact discs, DVD-RWs (rewritable) and DVD+RWs (rewritable), high density recording optical discs where information can be recorded at a high density by means of a semiconductor laser for emitting a laser beam with a short wavelength of about 405 nm (violet) and magneto-optical discs.

Particularly, this embodiment is designed to record information on and reproduce information from optical discs 100 of three different types by means of the optical pickup 1. They include optical discs 100a of the first type that typically include CDs (compact discs) having a cover thickness of 1.2 mm and adapted to be used with a light beam of a wavelength of about 780 nm for signal recording/reproduction, optical discs 100b of the second type that typically include DVDs (digital versatile discs) having a cover thickness of 0.6 mm and adapted to be used with a light beam of a wavelength of about 660 nm, optical discs 100c of the third type that typically include blue-ray discs having a cover thickness of 0.1 mm and adapted to be used with a light beam of a wavelength of about 405 nm for high density recording and optical discs 100d of the fourth type that typically include AODs (advanced optical discs) having a cover thickness of 0.6 mm and adapted to be used with a light beam of a wavelength of about 405 nm for high density recording.

In view of the wavelengths of light beams and the cover thicknesses of the disc-shaped recording mediums 100 to be used with a disc drive apparatus according to the invention, it is desirable that the numerical aperture of the objective lens arranged in the objective lens drive unit 8, which will be described in greater detail hereinafter, is about 0.65 for optical discs 100a of the first type, optical discs 100b of the second type and optical discs 100d of the fourth type and about 0.85 for optical discs 100c of the third type.

In the disc drive apparatus 1 having the above described configuration, as the disc table 3 is driven to rotate by the rotary motion of the spindle motor, the disc-shaped recording medium 100, which is selected from optical discs 100a, 100b, 100c, 100d of the first through fourth type and mounted on the disc table 3, is also driven to rotate and, at the same time, the optical pickup 6 is moved in a radial direction of the disc-shaped recording medium 100 to record information on or reproduce information from the disc-shaped recording medium 100. At this time, the movable section 8a of the objective lens drive unit 8 is moved relative to the fixed section 8b and a focusing adjusting operation and a tracking adjusting operation are conducted for the objective lens that is arranged in the movable section 8a as will be described in greater detail hereinafter.

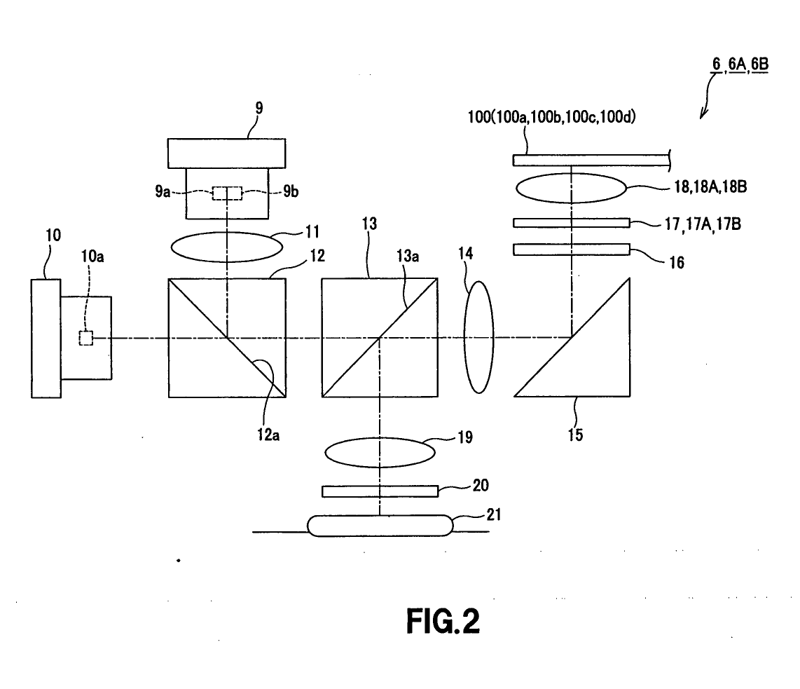

As shown in FIG. 2, the optical pickup 6 typically includes a first light source 9, a second light source 10, a coupling lens 11, a light path synthesizing element 12, a beam splitter 13, a collimator lens 14, an upturn mirror 15, a ¼ wave plate 16, a diffraction element 17, an objective lens 18, a conversion lens 19, an optical axis synthesizing element 20 and a light receiving element 21, all of which are arranged on the movable base 7 except the objective lens 18 that is arranged in the movable section 8a of the objective lens drive unit 8.

A first light emitting element 9a and a second light emitting element 9b are arranged in the inside of the first light source 9. The first light emitting element 9a is adapted to emit a laser beam of the first wavelength of about 780 nm for the optical disc 100a of the first type and the second light emitting element 9b is adapted to emit a laser beam of the second wavelength of about 660 nm for the optical disc 100b of the second type.

A third light emitting element 10a is arranged in the inside of the second light source 10. The third light emitting element 10a is adapted to emit a laser beam of the third wavelength of about 405 nm for the optical disc 100c of the third type or the optical disc 100d of the fourth type.

The coupling lens 11 operates to change the optical magnification of the laser beam emitted from the first light source 9 on the forward route thereof.

The light path synthesizing element 12 is typically a beam splitter having a mirror surface 12a that has wavelength selectivity. The laser beam of the first or second wavelength that is emitted from the first light emitting element 9a or the second light emitting element 9b, whichever appropriate, of the first light source 9 is reflected by the mirror surface 12a, whereas the laser beam of the third wavelength that is emitted from the third light emitting element 10a of the second light source 10 is transmitted through the mirror surface 12a.

The beam splitter 13 is a polarization beam splitter having a function of either transmitting or reflecting the incident laser beam depending on the direction of polarization of the laser beam. The laser beam is transmitted through the splitting surface 13a and directed toward the collimator lens 14 on the forward route thereof but reflected by the splitting surface 13a and directed toward the light receiving element 21 on the backward route thereof.

The collimator lens 14 has a function of collimating the flux of light of the incident laser beam.

The upturn mirror 15 has a function of reflecting the incident laser beam with an angle of about 90°.

The ¼ wave plate 16 has a function of giving a phase difference of the ¼ wavelength to the laser beam that passes through it and transforming linearly polarized light into circularly polarized light or vice versa.

The diffraction element 17 has a first diffracting section 22 and a second diffracting section 23 formed on the opposite surfaces thereof when an optical disc 100c of the third type is used as disc-shaped recording medium 100 that matches a laser beam of the third wavelength.

The first diffracting section 22 that is arranged at the side facing the upturn mirror 15 is adapted to diffract a laser beam of the third wavelength but substantially transmit a laser beam of the first wavelength and a laser beam of the second wavelength. Thus, the first diffracting section 22 operates as controlling diffracting section for controlling the extent of diffraction as a function of the wavelength of the incident laser beam.

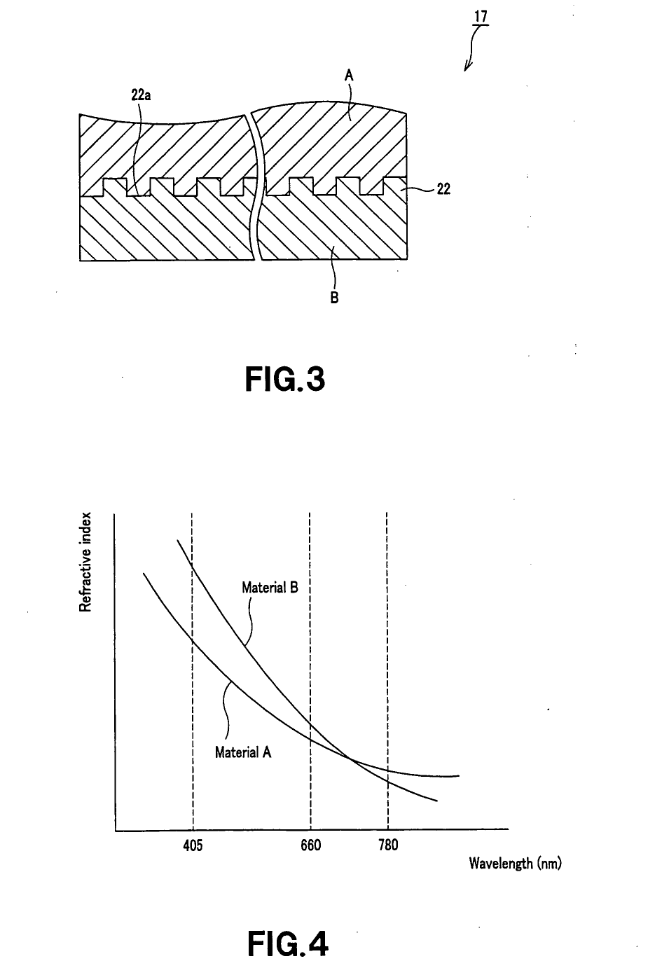

The first diffracting section 22 may be formed typically by bonding two materials A and B that show respective refractive indexes with different frequency characteristics and hence differ from each other in terms of dispersion characteristics to sandwich the diffraction surface 22a where a grating is formed as shown in FIG. 3. The material A and the material B are so selected that their refractive indexes do not differ significantly between the first wavelength (about 70 nm) and the second wavelength (about 660 nm) but come to differ remarkably at and near the third wavelength (about 405 nm).

Thus, it is possible to form a first diffracting section 22 that shows a desired diffraction efficiency by selecting an optimal combination of materials to be bonded together that differ from each other in terms of dispersion characteristics.

Alternatively, the first diffracting section 22 may be formed by laying a plurality of thin films having different refractive indexes to form a multilayer structure that diffracts a laser beam of the third wavelength but substantially transmits a laser beam of the first or second wavelength.

The second diffracting section 23 of the diffraction element 17 is formed so as to diffract a laser beam of any of the first through third wavelength.

The objective lens 18 has a function of focusing the incident laser beam to the recording surface of the disc-shaped recording medium 100. As shown in FIG. 5, the objective lens 18 has an outer peripheral section that is formed as an annular band 18a for adjusting the aperture of the lens that corresponds to a laser beam of the third wavelength. In other words, the part 18b of the objective lens 18 that is located inside the annular band 18a shows a numerical aperture of about 0.65 to correspond to a laser beam of the first or second wavelength and the combined part of the annular band 18a and the part 18b shows a numerical aperture of about 0.85 to correspond to a laser beam of the third wavelength.

The conversion lens 19 has a function of changing the optical magnification of the laser beam emitted from the first light source 9 or the second light source 10 on the forward route thereof.

The optical axis synthesizing element 20 has a function of synthesizing the optical axis of the laser beam emitted from the first light source 9 and that of the laser beam emitted from the second light source 10 and converging each of the laser beams to the light receiving element 21.

As a laser beam of the first wavelength or the second wavelength is emitted from the first light emitting element 9a or the second light emitting element 9b, whichever appropriate, of the first light source 9 of the optical pickup 6 having the above described configuration, its optical magnification is changed on the forward route thereof by the coupling lens 11 and then the laser beam is made to enter the light path synthesizing element 12. The laser beam that enters the light path synthesizing element 12 is reflected by the mirror surface 12a, subsequently transmitted through the splitting surface 13a of the beam splitter 13 and turned into a collimated flux of light by the collimator lens 14 and then reflected by the upturn mirror 15 to enter the ¼ wave plate 16. A phase difference of π/2 is added to the laser beam that enters the ¼ wave plate 16. The laser beam entering the ¼ wave plate 16 is a linearly polarized (P-polarized) laser beam but then circularly polarized and made to enter the diffraction element 17. The laser beam that enters the diffraction element 17 is substantially transmitted through the first diffracting section 22 and diffracted by the second diffracting section 23 and made to enter the part 18b of the objective lens 18 so that it is focused onto the recording surface of the optical disc 100a of the first type or the optical disc 100b of the second type that is mounted on the disc table 3.

The laser beam that is focused on the recording surface of the optical disc 100a of the first type or the optical disc 100b of the second type is reflected by the recording surface and enters again the ¼ wave plate 16 as return light by way of the objective lens 18 and the diffraction element 17. A phase difference of π/2 is added to the laser beam that enters the ¼ wave plate 16. The laser beam entering the ¼ wave plate 16 is a circularly polarized laser beam but then linearly polarized (S-polarized) and made to enter the beam splitter 13 by way of the upturn mirror 15 and the collimator lens 14. The return light that enters the beam splitter 13 is reflected by the splitting surface 13a of the beam splitter 13 with its optical magnification changed by the conversion lens 19 on the backward route thereof and made to enter the light receiving element 21 by way of the optical axis synthesizing element 20. The laser beam that enters the light receiving element 21 is subjected to photoelectric conversion. Thus, information signals are recorded on or reproduced from the optical disc 100a of the first type or the optical disc 100b of the second type.

On the other hand, as a laser beam of the third wavelength is emitted from the third light emitting element 10a of the second light source 10, it is made to enter the light path synthesizing element 12. The laser beam that enters the light path synthesizing element 12 is transmitted through the mirror surface 12a and subsequently through the splitting surface 13a of the beam splitter 13, collimated by the collimator lens 14 and then reflected by the upturn mirror 15 to enter the ¼ wave plate 16. A phase difference of π/2 is added to the laser beam that enters the ¼ wave plate 16. The laser beam entering the ¼ wave plate 16 is a linearly polarized (P-polarized) laser beam but then circularly polarized and made to enter the diffraction element 17. The laser beam that enters the diffraction element 17 is diffracted by the first diffracting section 22 and the second diffracting section 23 and made to enter the annular band 18a of the objective lens 18 so that it is focused onto the recording surface of the optical disc 100c of the third type that is mounted on the disc table 3.

The laser beam that is focused on the recording surface of the optical disc 100c of the third type is reflected by the recording surface and enters again the ¼ wave plate 16 as return light by way of the objective lens 18 and the diffraction element 17. A phase difference of π/2 is added to the laser beam that enters the ¼ wave plate 16. The laser beam entering the ¼ wave plate 16 is a circularly polarized laser beam but then linearly polarized (S-polarized) and made to enter the beam splitter 13 by way of the upturn mirror 15 and the collimator lens 14. The return light that enters the beam splitter 13 is reflected by the splitting surface, 13a of the beam splitter 13 with its optical magnification changed by the conversion lens 19 on the backward route thereof and made to enter the light receiving element 21 by way of the optical axis synthesizing element 20. The laser beam that enters the light receiving element 21 is subjected to photoelectric conversion. Thus, information signals are recorded on or reproduced from the optical disc 100c of the third type.

While the laser beam of the third wavelength is diffracted by the first diffracting section 22 of the diffraction element 17 whereas the laser beam of the first or second wavelength is substantially transmitted through first diffracting section 22 of the diffraction element 17 in the above description, it may alternatively be so arranged that the laser beam of the first or second wavelength is diffracted by the first diffracting section 22 of the diffraction element 17 whereas the laser beam of the third wavelength is substantially transmitted through the first diffracting section 22 of the diffraction element 17 so that the laser beam of the first or second wavelength enters the part 18b of the objective lens 18 while the laser beam of the third wavelength enters the annular band 18a of the objective lens 18.

With the above described arrangement of using an objective lens 18 having an annular band 18a for adjusting the aperture of the lens and a diffraction element 17 having a first diffracting section 22 that operates as controlling diffracting section and a second diffracting section 23 that diffracts a laser beam of any wavelength formed on the opposite surfaces thereof, it is possible to properly record information signals on and reproduce information signals from disc-shaped recording mediums 100 of the three different types including optical discs 100a, 100b, 100c of the first through third type by means of a single objective lens 18.

In this way, a laser beam of any of the three different wavelengths is focused on the recording surface of the optical disc of the corresponding type that is mounted on the disc table 3 by means of the single objective lens of the optical pickup 6 according to the present invention.

As either the first diffracting section 22 or the second diffracting section 23 is arranged to operate as controlling diffracting section and the laser beam of one of the first through third wavelengths or the laser beams of two of the first through third wavelengths are substantially transmitted through the controlling diffracting section in the optical pickup 6 according to the invention, it is possible to properly record information signals on and reproduce information signals from disc-shaped recording mediums of the three different types, which correspond respectively to laser beams of three different wavelengths, by means of the single objective lens 18 of the optical pickup 6 according to the invention.

Additionally, as information signals can be recorded on and reproduced from disc-shaped recording mediums of the three different types, which correspond respectively to laser beams of different wavelengths, by means of the single objective lens 18 of the optical pickup 6 according to the invention, it is possible to reduce the number of components and hence both the dimensions of the optical pickup and the manufacturing cost. Furthermore, since the optical pickup 6 according to the invention is adapted to use a single objective lens 18, the weight of the movable part of objective lens drive unit is reduced to secure an excellent the responsiveness of the movable part in the focusing control operation and the tracking control operation.

Still additionally, as the objective lens 18 of the optical pickup 6 according to the invention is provided with an annular band 18a for adjusting the aperture of the lens and two diffracting sections 22 and 23 are arranged respectively on the surface of incidence and the light emitting surface of the diffraction element 17 so as to use one of the diffracting sections, or the diffracting section 22, as controlling diffracting section, it is possible to properly record information signals on and reproduce information signals from disc-shaped recording mediums 100 of the three different types including optical discs 100a, 100b, 100c of the first through third types by means of a single objective lens 18.

Still additionally, as the controlling diffracting section of the optical pickup 6 according to the invention is formed by bonding two materials A and B that show different dispersion characteristics, it is possible to form the diffracting section so as to make it show a desired diffraction efficiency by selecting optimal materials for the combination of materials.

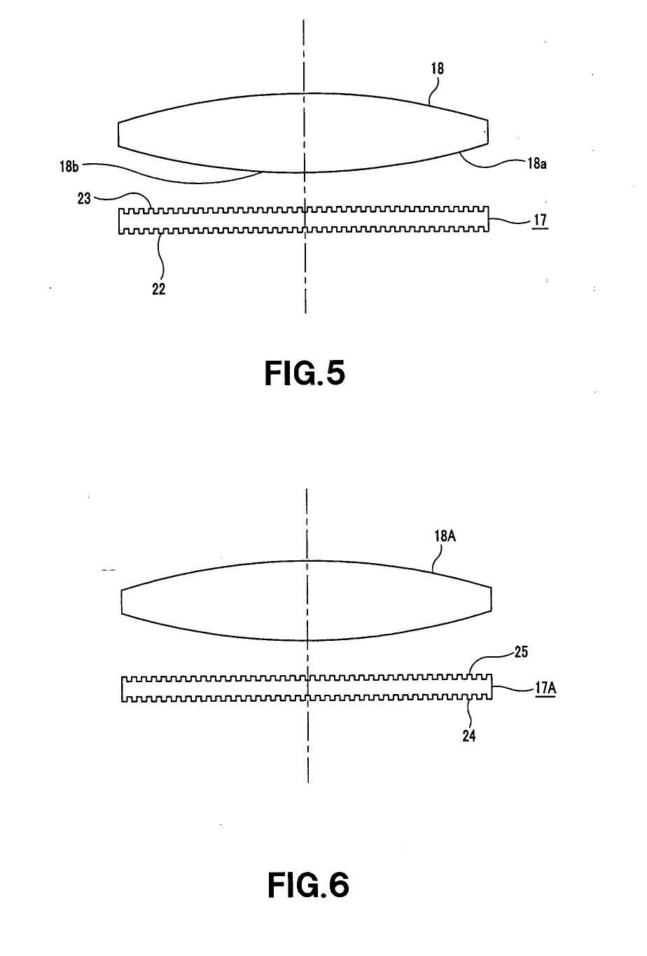

While the embodiment of disc drive apparatus is described above in terms of an optical disc 100c of the third type that is a disc-shaped recording medium 100 on which information signals are recorded and from which information signals are reproduced by means of a laser beam of the third wavelength, an optical pickup 6A having a diffraction element 17A and an objective lens 18A as shown in FIG. 6 is typically employed when an optical disc 100d of the fourth type is used as disc-shaped recording medium 100 so as to record information signals on and reproduce information signals from it by means of a laser beam of the third wavelength (about 405 nm).

Now, the optical pickup 6A to be used for recording information signals on and reproducing information signals from an optical disc 100d of the fourth type will be described below in detail. The optical pickup 6A to be used for an optical disc 100d of the fourth type differs from the optical pickup 6 to be used for an optical disc 100c of the third type only in the configuration of the diffraction element and that of the objective lens. In the following description, the components that are common to the optical pickup 6A and the above described optical pickup 6 are denoted respectively by the same reference symbols and will not be described any further.

As shown in FIG. 2, the optical pickup 6A typically includes a first light source 9, a second light source 10, a coupling lens 11, a light path synthesizing element 12, a beam splitter 13, a collimator lens 14, an upturn mirror 15, a ¼ wave plate 16, a diffraction element 17A, an objective lens 18A, a conversion lens 19, an optical axis synthesizing element 20 and a light receiving element 21, all of which are arranged on the movable base 7 except the objective lens 18A that is arranged in the movable section 8a of the objective lens drive unit 8.

As shown in FIG. 6, the diffraction element 17A has a first diffracting section 24 and a second diffracting section 25 arranged respectively on the opposite surfaces thereof. The diffraction element 17A has a configuration similar to the above described diffraction element 17.

The first diffracting section 24 that is arranged at the side facing the upturn mirror 15 is adapted to diffract a laser beam of the third wavelength but substantially transmit a laser beam of the first or second wavelength. Thus, the first diffracting section 24 operates as controlling diffracting section for controlling the extent of diffraction as a function of the wavelength of the incident laser beam.

The second diffracting section 25 of the diffraction element 17A is formed so as to diffract a laser beam of any of the first through third wavelength.

Unlike the above described objective lens 18, the objective lens 18A is not provided with an annular band and the numerical aperture of the objective lens 18A is about 0.65.

As a laser beam of the first wavelength or the second wavelength is emitted from the first light emitting element 9a or the second light emitting element 9b, whichever appropriate, of the first light source 9 of the optical pickup 6A having the above described configuration, it is made to enter the diffraction element 17A by way of the light path similar to that of the above described optical pickup 6. The laser beam that enters the diffraction element 17A is substantially transmitted through the first diffracting section 24 of the diffraction element 17A and diffracted by the second diffracting section 25 and made to enter the objective lens 18A so that it is focused onto the recording surface of the optical disc 100a of the first type or the optical disc 100b of the second type that is mounted on the disc table 3 to record information signals on or reproduce information signals from the optical disc 100a of the first type or the optical disc 100b of the second type. The light path of the return light reflected by the recording surface of the optical disc 100a of the first type or the optical disc 100b of the second type is same as that of the above described optical pickup 6 and hence will not be described here any further.

On the other hand, as a laser beam of the third wavelength is emitted from the third light emitting element 10a of the second light source 10, it is made to enter the diffraction element 17A by way of the light path similar to that of the above described optical pickup 6 and diffracted by the first diffracting section 24 and the second diffracting section 25 of the diffraction element 17A. Then, it is made to enter the objective lens 18A so that it is focused onto the recording surface of the optical disc 100d of the fourth type that is mounted on the disc table 3 to record information signals on or reproduce information signals from the optical disc 100d of the fourth type. The light path of the return light reflected by the recording surface of the optical disc 100d of the fourth type is same as that of the above described optical pickup 6 and hence will not be described here any further.

With the above described arrangement of using a diffraction element 17A having a first diffracting section 24 that operates as controlling diffracting section and a second diffracting section 25 that diffracts a laser beam of any wavelength formed on the opposite surfaces of thereof, it is possible to properly record information signals on and reproduce information signals from disc-shaped recording mediums 100 of the three different types including optical discs 100a of the first type, optical discs 100b of the second type and optical discs 100d of the fourth type by means of a single objective lens 18A.

In this way, a laser beam of any of the three different wavelengths is focused on the recording surface of the optical disc of the corresponding type that is mounted on the disc table 3 by means of the single objective lens of the optical pickup 6A according to the present invention.

As either the first diffracting section 24 or the second diffracting section 25 is arranged to operate as controlling diffracting section and the laser beam of one of the first through third wavelengths or the laser beams of two of the first through third wavelengths are substantially transmitted through the controlling diffracting section in the optical pickup 6A according to the invention, it is possible to properly record information signals on and reproduce information signals from disc-shaped recording mediums of the three different types, which correspond respectively to laser beams of three different wavelengths, by means of the single objective lens 18A.

Additionally, as information signals can be recorded on and reproduced from disc-shaped recording mediums of the three different types, which correspond respectively to laser beams of different wavelengths, by means of the single objective lens 18A of the optical pickup 6A according to the invention, it is possible to reduce the number of components and hence both the dimensions of the optical pickup and the manufacturing cost. Furthermore, since the optical pickup 6A according to the invention is adapted to use a single objective lens 18A, the weight of the movable part of objective lens drive unit is reduced to secure an excellent responsiveness of the movable part in the focusing control operation and the tracking control operation.

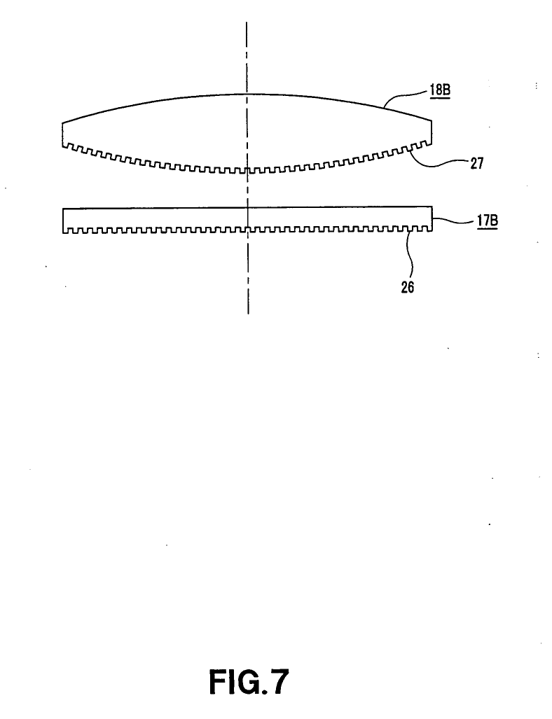

An optical pickup 6B having a diffraction element and an objective lens as shown in FIG. 7 may alternatively be employed when an optical disc 100d of the fourth type is used as disc-shaped recording medium 100 so as to record information signals on and reproduce information signals from it.

Now, the optical pickup 6B to be used for recording information signals on and reproducing information signals from an optical disc 100d of the fourth type will be described below in detail. If compared with the optical pickup 6, the optical pickup 6B to be used for an optical disc 100d of the fourth type differs from the optical pickup 6 to be used for an optical disc 100c of the third type only in the configuration of the diffraction element and that of the objective lens. In the following description, the components that are common to the optical pickup 6B and the above described optical pickup 6 are denoted respectively by the same reference symbols and will not be described any further.

As shown in FIG. 2, the optical pickup 6B typically includes a first light source 9, a second light source 10, a coupling lens 11, a light path synthesizing element 12, a beam splitter 13, a collimator lens 14, an upturn mirror 15, a ¼ wave plate 16, a diffraction element 17B, an objective lens 18B, a conversion lens 19, an optical axis synthesizing element 20 and a light receiving element 21, all of which are arranged on the movable base 7 except the objective lens 18B that is arranged in the movable section 8a of the objective lens drive unit 8.

The diffraction element 17B only has a first diffracting section 26 arranged on one of the opposite surfaces thereof. The first diffracting section 26 is adapted to diffract a laser beam of the third wavelength but substantially transmit a laser beam of the first or second wavelength. Thus, the first diffracting section 26 operates as controlling diffracting section for controlling the extent of diffraction as a function of the wavelength of the incident laser beam. The first diffracting section 26 of the diffraction element 17B may be formed like the first diffracting section 22 of the above described diffraction element 17. In other words, it may be formed by bonding two materials that show respective refractive indexes with different frequency characteristics.

Unlike the above-described objective lens 18, the objective lens 18B is not provided with an annular band and the numerical aperture of the objective lens 18B is about 0.65. A second diffracting section 27 is formed on the surface of the objective lens 18B that is located vis-à-vis the diffraction element 17B. The second diffracting section 27 is adapted to diffract a laser beam of any of the first through third wavelength.

As a laser beam of the first wavelength or the second wavelength is emitted from the first light emitting element 9a or the second light emitting element 9b, whichever appropriate, of the first light source 9 of the optical pickup 6B having the above described configuration, it is made to enter the diffraction element 17B by way of the light path similar to that of the above described optical pickup 6. The laser beam that enters the diffraction element 17B is substantially transmitted through the first diffracting section 26, made to enter the objective lens 18B and diffracted by the second diffracting section 27 so that it is focused onto the recording surface of the optical disc 100a of the first type or the optical disc 100b of the second type that is mounted on the disc table 3 to record information signals on or reproduce information signals from the optical disc 100a of the first type or the optical disc 100b of the second type. The light path of the return light reflected by the recording surface of the optical disc 100a of the first type or the optical disc 100b of the second type is same as that of the above described optical pickup 6 and hence will not be described here any further.

On the other hand, as a laser beam of the third wavelength is emitted from the third light emitting element 10a of the second light source 10 of the optical pickup 6B, it is made to enter the diffraction element 17B by way of the light path similar to that of the above described optical pickup 6 and diffracted by the first diffracting section 26 of the diffraction element 17B and the second diffracting section 27 of the objective lens 18B. Then, it is focused onto the recording surface of the optical disc 100d of the fourth type that is mounted on the disc table 3 to record information signals on or reproduce information signals from the optical disc 100d of the fourth type. The light path of the return light reflected by the recording surface of the optical disc 100d of the fourth type is same as that of the above described optical pickup 6 and hence will not be described here any further.

With the above described arrangement of using a diffraction element 17B having a first diffracting section 26 that operates as controlling diffracting section and an objective lens 18B having a second diffracting section 27 that diffracts a laser beam of any wavelength, it is possible to properly record information signals on and reproduce information signals from disc-shaped recording mediums 100 of the three different types including optical discs 100a of the first type, optical discs 100b of the second type and optical discs 100d of the fourth type by means of a single objective lens 18B.

In this way, a laser beam of any of the three different wavelengths is focused on the recording surface of the optical disc of the corresponding type that is mounted on the disc table 3 by means of the single objective lens of the optical pickup 6B according to the present invention.

As either the first diffracting section 26 or the second diffracting section 27 is arranged to operate as controlling diffracting section and the laser beam of one of the first through third wavelengths or the laser beams of two of the first through third wavelengths are substantially transmitted through the controlling diffracting section in the optical pickup 6B according to the invention, it is possible to properly record information signals on and reproduce information signals from disc-shaped recording mediums of the three different types, which correspond respectively to laser beams of three different wavelengths, by means of the single objective lens 18B.

Additionally, as information signals can be recorded on and reproduced from disc-shaped recording mediums of the three different types, which correspond respectively to laser beams of different wavelengths, by means of the single objective lens 18B of the optical pickup 6B according to the invention, it is possible to reduce the number of components and hence both the dimensions of the optical pickup and the manufacturing cost. Furthermore, since the optical pickup 6B according to the invention is adapted to use a single objective lens 18B, the weight of the movable part of objective lens drive unit is reduced to secure an excellent responsiveness of the movable part in the focusing control operation and the tracking control operation.

As diffracting sections 26, 27 are formed respectively on one of the opposite surfaces of the objective lens 18B and on one of the opposite surfaces of the diffraction element 17B and the diffracting section 26 of the diffraction element 17B is made to operate as controlling diffracting section, it is possible to properly record information signals on and reproduce information signals from disc-shaped recording mediums of the three different types including optical discs 100a of the first type, optical discs 100b of the second type and optical discs 100d of the fourth type by means of the single objective lens 18B of the optical pickup 6B according to the invention.

Like the optical pickup 6 adapted to record information signals on and reproduce information signals from optical discs 100c of the third type, the optical pickups 6A, 6B adapted to record information signals on and reproduce information signals from optical discs 100d of the fourth type may be so arranged that the first diffracting section 24 of the diffraction element 17A and the first diffracting section 26 of the diffraction element 17B diffract laser beams of the first and second wavelengths but substantially transmit a laser beam of the third wavelength.

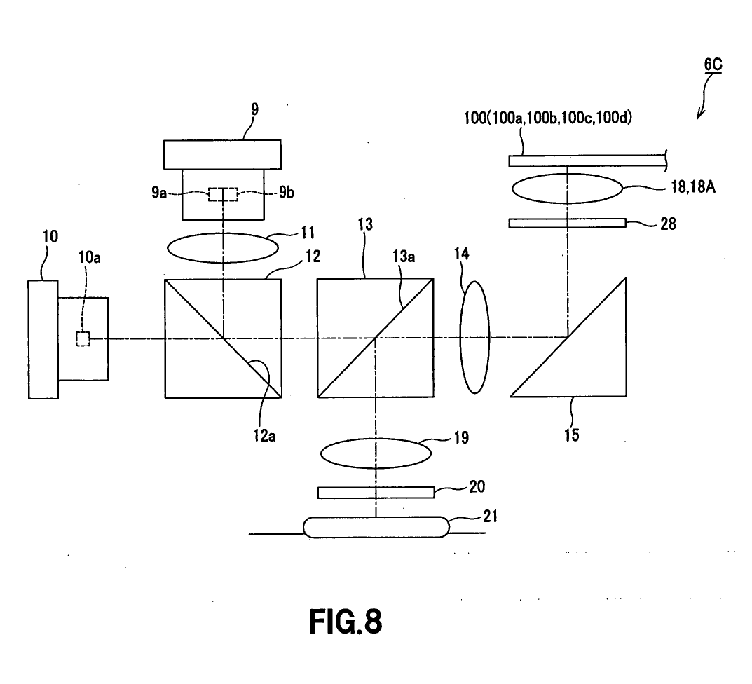

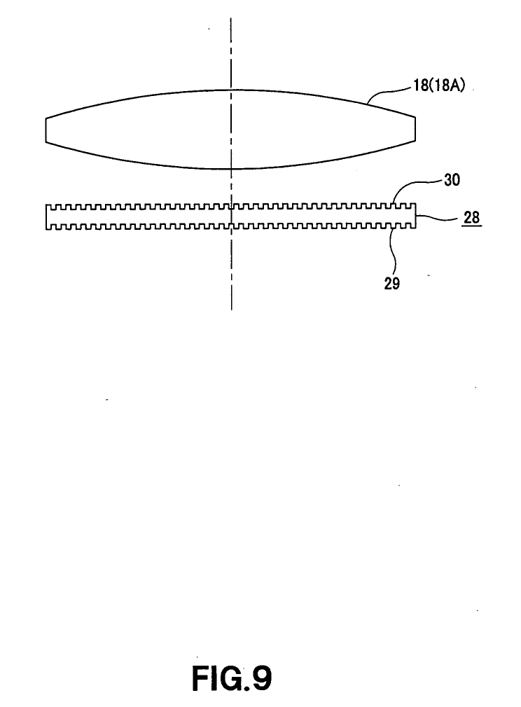

While the above described optical pickups 6, 6A, 6B respectively have diffracting sections formed on the diffraction elements 17, 17A, 17B and the objective lens 18B in the above description, a polarization hologram element may alternatively be used to diffract a laser beam as in the case of the optical pickup 6C illustrated in FIGS. 8 and 9.

Now, the optical pickup 6C including a polarization hologram element will be described below. The optical pickup 6C adapted to diffract a laser beam by means of a polarization hologram element differs from the optical pickups 6, 6A, 6B only in that the diffraction elements of those optical pickups are replaced by a polarization hologram element. In the following description, the components that are common to the optical pickup 6C and the above described optical pickup 6 are denoted respectively by the same reference symbols and will not be described any further.

As shown in FIGS. 8 and 9, the optical pickup 6C typically includes a first light source 9, a second light source 10, a coupling lens 11, a light path synthesizing element 12, a beam splitter 13, a collimator lens 14, an upturn mirror 15, a polarization hologram element 28, an objective lens 18 (18A), a conversion lens 19, an optical axis synthesizing element 20 and a light receiving element 21, all of which are arranged on the movable base 7 except the objective lens 18 (18A) that is arranged in the movable section 8a of the objective lens drive unit 8.

The disc-shaped recording medium 100 on which information signals are recorded and from which information signals are reproduced by means of a laser beam of the third wavelength in the optical pickup 6C adapted to diffract laser beams by means of a polarization hologram element may be an optical disc 100c of the third type or an optical disc 100d of the fourth type.

The polarization hologram element 28 has a first diffracting section 29 and a second diffracting section 30 formed respectively on the opposite surfaces thereof.

The first diffracting section 29 is formed on the surface of the polarization hologram element 28 located vis-à-vis the upturn mirror 15 is typically adapted to diffract P-polarized light and transmit S-polarized light, whereas the second diffracting section 30 arranged on the opposite surface of the polarization hologram element 28 is typically adapted to diffract S-polarized light and transmit P-polarized light. Therefore, both the first diffracting section 29 and the second diffracting section 30 are controlling diffracting sections that diffract the incident laser beam depending on the sense of polarization of the beam.

The objective lens 18 is used when the disc-shaped recording medium 100 on which information signals are recorded and from which information signals are reproduced by means of a laser beam of the third wavelength is an optical disc 100c of the third type, whereas the objective lens 18A is used when the disc-shaped recording medium 100 is an optical disc 100d of the fourth type.

Since linearly polarized light is focused onto the recording surface of the disc-shaped recording medium 100 by the optical pickup 6C adapted to diffract a laser beam by means of a polarization hologram element 28, no ¼ wave plate is used unlike the above described optical pickups 6, 6A, 6B.

In the optical pickup 6C having the above described configuration, the laser beam emitted from the first light emitting element 9a or the second light emitting element 9b of the first light source 9 may be S-polarized light and, as emitted S-polarized light enters the polarization hologram element 28, it is diffracted only by the second diffracting section 30. The laser beam of diffracted S-polarized light is focused on the optical disc 100a of the first type or the optical disc 100b of the second type that is mounted on the disc table 3 by the objective lens 18 or the objective lens 18A to record information signals on or reproduce information signals from the optical disc 100a of the first type or the optical disc 100b of the second type, whichever appropriate.

On the other hand, the laser beam of a wavelength of about 405 nm emitted from the third light emitting element 10a of the second light source 10 may be P-polarized light and, as emitted P-polarized light enters the polarization hologram element 28, it is diffracted only by the first diffracting section 29. The laser beam of diffracted P-polarized light is focused on the recording surface of the optical disc 100c of the third type or the optical disc 100d of the fourth type that is mounted on the disc table 3 by the objective lens 18 or the objective lens 18A to record information signals on or reproduce information signals from the optical disc 100c of the third type or the optical disc 100d of the fourth type, whichever appropriate.

While the sense of polarization of the laser beams of the first wavelength and the second wavelength and that of the laser beam of the third wavelength are orthogonal relative to each other in the above described example, it may alternatively be so arranged that the sense of polarization of the laser beam of the first wavelength and that of the laser beams of the second wavelength and the third wavelength are orthogonal relative to each other.

Thus, it is possible to record information signals on and reproduce information signals from disc-shaped recording mediums 100 of three different types that are used respectively with laser beams of different wavelengths by means of a single objective lens 18 or objective lens 18A when a laser beam is diffracted by means of a polarization hologram element 28. Thus, it is possible to simplify the overall configuration of the optical pickup.

In this way, a laser beam of any of the three different wavelengths is focused on the recording surface of the optical disc of the corresponding type that is mounted on the disc table 3 by means of the single objective lens of the optical pickup 6C according to the present invention.

As either the first diffracting section 29 or the second diffracting section 30 is arranged to operate as controlling diffracting section and the laser beam of one of the first through third wavelengths or the laser beams of two of the first through third wavelengths are substantially transmitted through the controlling diffracting section in the optical pickup 6C according to the invention, it is possible to properly record information signals on and reproduce information signals from disc-shaped recording mediums of the three different types, which correspond respectively to laser beams of three different wavelengths, by means of the single objective lens of the optical pickup 6C according to the invention.

Additionally, as information signals can be recorded on and reproduced from disc-shaped recording mediums of the three different types, which correspond respectively to laser beams of different wavelengths, by means of the single objective lens of the optical pickup 6C according to the invention, it is possible to reduce the number of components and hence both the dimensions of the optical pickup and the manufacturing cost. Furthermore, since the optical pickup 6C according to the invention is adapted to use a single objective lens, the weight of the movable part of objective lens drive unit is reduced to secure an excellent responsiveness of the movable part in the focusing control operation and the tracking control operation.

As the optical pickup 6C according to the invention includes a polarization hologram element 28 that is adapted to operate as diffraction element and diffracting sections are formed respectively on the surface of incidence and on the light emitting surface thereof so that a laser beam selected from laser beams of polarized light whose senses of polarization are orthogonal relative to each other enters the polarization hologram element and the diffracting sections 29, 30 of the polarization hologram element operate as controlling diffracting sections, it is possible to properly record information signals on and reproduce information signals from disc-shaped recording mediums of the three different types by means of the single objective lens of the optical pickup 6C according to the invention.

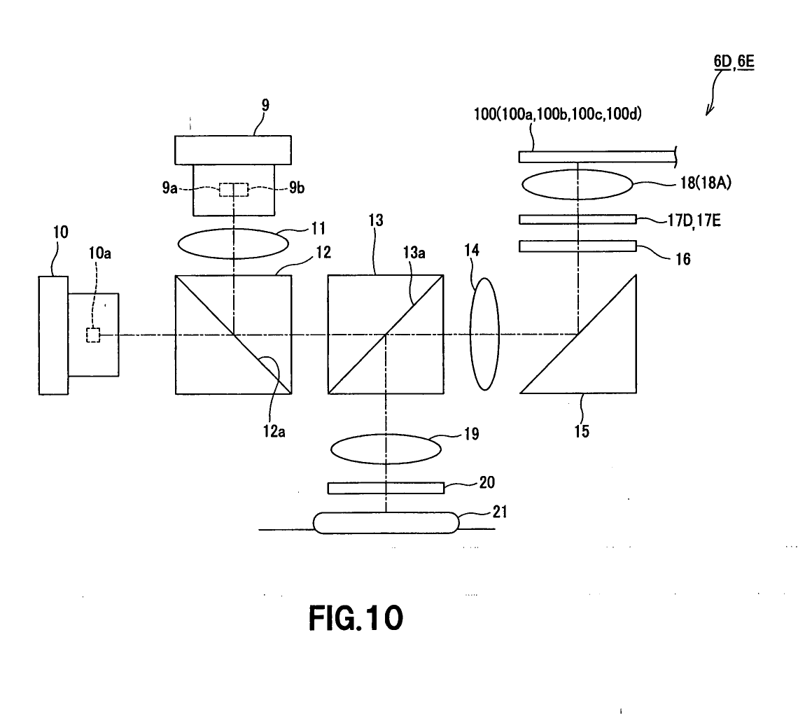

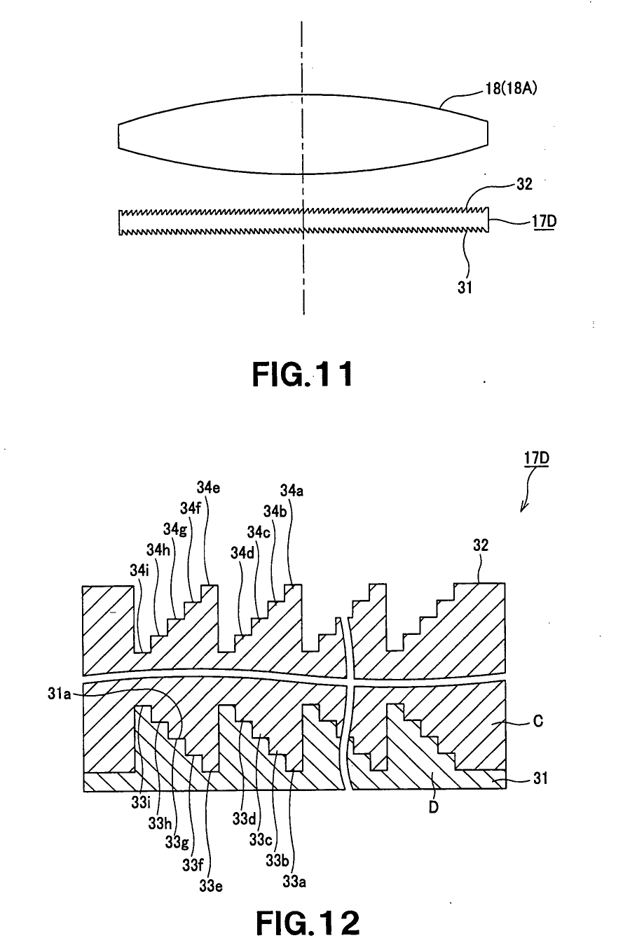

While the above described optical pickups 6, 6A, 6B, 6C have first and second diffracting sections that are so-called diffraction grating type two-stepped diffracting sections, the present invention is by no means limited thereto and the diffracting sections may alternatively be formed by holograms showing a staircase-like profile as in the case of the optical pickup 6D illustrated in FIGS. 10 and 11.

Now, the optical pickup 6D including staircase-like diffracting sections will be described below. The optical pickup 6D differs from the above-described optical pickup 6 having the diffraction element 17 and the objective lens 18 only in terms of the configuration of the diffraction element and that of the objective lens. In the following description, the components that are common to the optical pickup 6D and the above described optical pickup 6 are denoted respectively by the same reference symbols and will not be described any further.

As shown in FIGS. 10 and 11, the optical pickup 6D typically includes a first light source 9, a second light source 10, a coupling lens 11, a light path synthesizing element 12, a beam splitter 13, a collimator lens 14, an upturn mirror 15, a ¼ wave plate 16, a diffraction element 17D, an objective lens 18 (18A), a conversion lens 19, an optical axis synthesizing element 20 and a light receiving element 21, all of which are arranged on the movable base 7 except the objective lens 18 (18A) that is arranged in the movable section 8a of the objective lens drive unit 8.

As shown in FIGS. 11 and 12, the diffraction element 17D has a first diffracting section 31 and a second diffracting section 32 arranged respectively on the opposite surfaces thereof. Holograms are formed respectively in the first diffracting section 31 and the second diffracting section 32 of the diffraction element 17D. The holograms show a profile like that of staircases having five steps respectively including the first through fourth steps 33a through 33d, 34a through 34d of a same depth. In other words, the holograms have respective diffraction planes including the first through fifth diffraction planes 33e through 33i, 34e through 34i that are arranged at regular intervals. While the number of steps of the staircase-like profile that defines the number of diffraction planes is five in this embodiment, the number of steps is by no means limited to five.

The first diffracting section 31 arranged at the side located vis-à-vis the upturn mirror 15 is formed by bonding two different members to be bonded that show respective refractive indexes, more specifically two different members to be bonded that show respective refractive indexes whose frequency characteristics are different from each other. A desired diffraction efficiency can be achieved when the difference between the refractive index of the member that operates as the substrate of the first diffracting section 31 and that of the member to be bonded is not smaller than 0.05. A desired diffraction efficiency can be achieved when the refractive index of the member that operates as the substrate is not higher than 1.55 and that of the member to be bonded is not lower than 1.60. Both the member that operates as the substrate and the member to be bonded are typically made of synthetic resin. As shown in FIG. 12, the first diffracting section 31 is formed by bonding material C and material D that show different refractive indexes so as to sandwich the diffraction surface 31a showing a profile like that of staircases having five steps. Table 1 below shows the refractive index of the material C and that of the material D for the different wavelengths to be used.

TABLE 1

| | wavelength (nm) | | |
|---|---|---|---|
| | first | second | third |
| | wavelength 780 | wavelength 660 | wavelength 405 |
| material C | 1.50482 | 1.50678 | 1.52433 |
| material D | 1.62 | 1.6355 | 1.68396 |

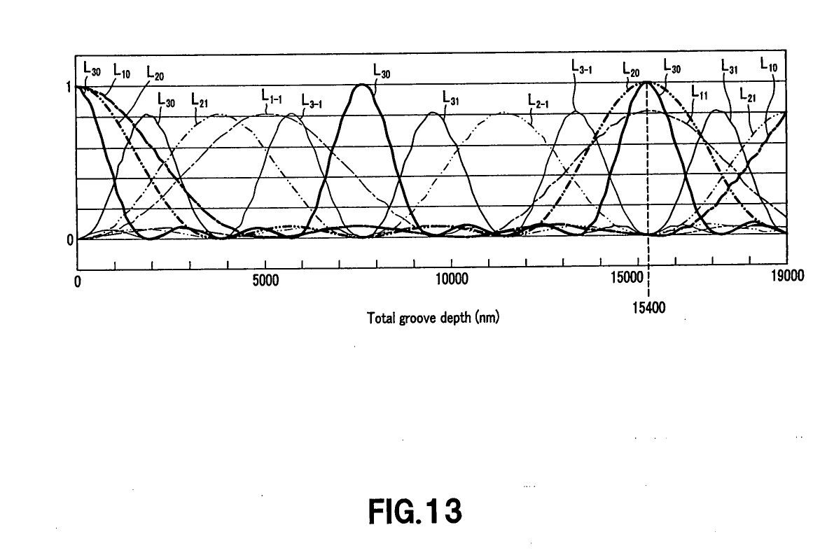

FIG. 13 shows the diffraction efficiency of the first diffracting section 31 having a profile like that of a staircase having five steps and made of the material C and the material D listed in Table 1 that varies as a function of the change in the total groove depth. The expression of total groove depth as used herein refers to the total of the depths of the above-described first through fourth steps 33a through 33d. The steps are made to show a substantially same depth (the gap separating any two adjacently located ones of the first through fifth diffraction planes). In FIG. 13, each of the curves indicates the ratio of the total quantity of incident light of the laser beam to the quantity of diffracted light of the laser beam, which is the diffraction efficiency. In FIG. 13, the curves L₁₀, L₁₁ and L₁₋₁ are respectively for diffracted (transmitted) light of the 0-th degree, diffracted light of the 1st degree and that of the −1 st degree of a laser beam with a wavelength of 780 nm (the first wavelength) and the curves L₂₀, L₂₁ and L₂₋₁ are respectively for diffracted (transmitted) light of the 0-th degree, diffracted light of the 1st degree and that of the −1st degree of a laser beam with a wavelength of 660 nm (the second wavelength), whereas the curves L₃₀, L₃₁ and L₃₋₁ are respectively for diffracted (transmitted) light of the 0-th degree, diffracted light of the 1st degree and that of the −1st degree of a laser beam with a wavelength of 405 nm (the third wavelength).

Table 2 below shows the diffraction efficiency of diffracted light of the 1st degree of a laser beam with a wavelength of 780 nm (the first wavelength), the diffraction efficiency (transmittance) of diffracted light of the 0-th degree of a laser beam with a wavelength of 660 nm (the second wavelength) and the diffraction efficiency (transmittance) of diffracted light of the 0-th degree of a laser beam with a wavelength of 405 nm (the third wavelength) when the total groove depth of the first diffracting section 31 of the optical pickup 6D is made equal to 15.4 μm (15,400 nm).

TABLE 2

| | wavelength (nm) | | |
|---|---|---|---|
| | first | second | third |
| | wavelength 780 | wavelength 660 | wavelength 405 |
| | (1st degree) | (0-th degree) | (0-th degree) |
| transmittance/ | 81% | 100% | 100% |
| diffraction | | | |
| efficiency, | | | |
| 1st diffracting | | | |
| section | | | |
| 31 (depth = | | | |
| 15.4 μm) | | | |

The second diffracting section 32 arranged at the side located vis-à-vis the objective lens 18 (18A) has its diffraction surface 32a showing a profile like that of a staircase having five steps exposed to air, as shown in FIG. 12, and is made of material C listed in Table 1 above.

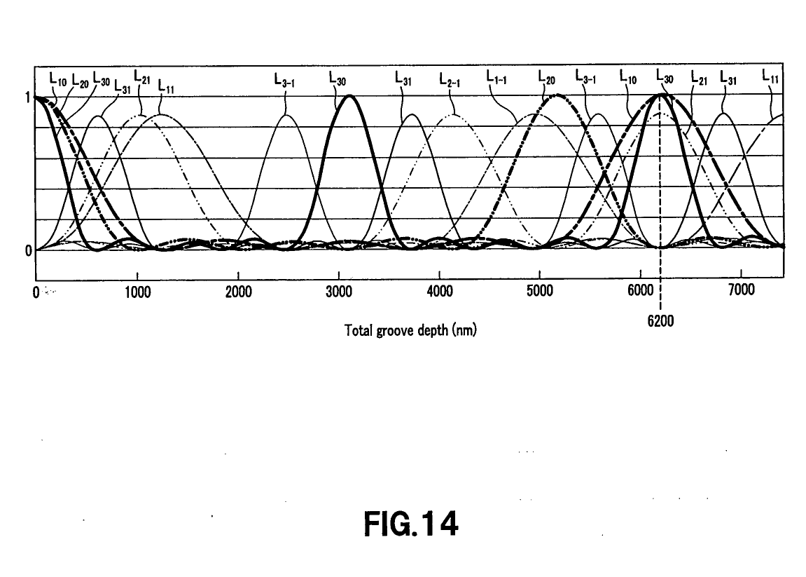

FIG. 14 shows the diffraction efficiency of the second diffracting section 32 having a profile like that of a staircase having five steps and made of the material C listed in Table 1 that varies as a function of the change in the total groove depth. The expression of total groove depth as used herein refers to the total of the depths of the above described first through fourth steps 34a through 34d. The steps are made to show a substantially same depth (the gap separating any two adjacently located ones of the first through fifth diffraction planes). In FIG. 14, each of the curves indicates the ratio of the total quantity of incident light of the laser beam to the quantity of diffracted light of the laser beam, which is the diffraction efficiency. In FIG. 14, the curves L₁₀, L₁₁ and L₁₋₁ are respectively for diffracted (transmitted) light of the 0-th degree, diffracted light of the 1st degree and that of the −1st degree of a laser beam with a wavelength of 780 nm (the first wavelength) and the curves L₂₀, L₂₁ and L₂₋₁ are respectively for diffracted (transmitted) light of the 0-th degree, diffracted light of the 1st degree and that of the −1st degree of a laser beam with a wavelength of 660 nm (the second wavelength), whereas the curves L₃₀, L₃₁ and L₃₋₁ are respectively for diffracted (transmitted) light of the 0-th degree, diffracted light of the 1st degree and that of the −1st degree of a laser beam with a wavelength of 405 nm (the third wavelength).

Table 3 below shows the diffraction efficiency (transmittance) of diffracted light of the 0-th degree of a laser beam with a wavelength of 780 nm (the first, wavelength), the diffraction efficiency of diffracted light of the 1st degree of a laser beam with a wavelength of 660 nm (the second wavelength) and the diffraction efficiency (transmittance) of diffracted light of the 0-th degree of a laser beam with a wavelength of 405 nm (the third wavelength) when the total groove depth of the second diffracting section 32 of the optical pickup 6D is made equal to 6.2 μm (6200 nm).

TABLE 3

| | wavelength (nm) | | |
|---|---|---|---|
| | first | second | third |
| | wavelength 780 | wavelength 660 | wavelength 405 |
| | (0-th degree) | (1st degree) | (0-th degree) |
| transmittance/ | 100% | 88% | 100% |
| diffraction | | | |
| efficiency, | | | |
| 2nd diffracting | | | |
| section | | | |
| 32 (depth = | | | |
| 6.2 μm) | | | |

As pointed out earlier, the first diffracting section 31 is adapted to diffract a laser beam of the first wavelength but substantially transmits a laser beam of the second wavelength and a laser beam of the third wavelength. In other words, the first diffracting section 31 operates as first controlling diffracting section for controlling the extent of diffraction as a function of the wavelength of the incident laser beam.

The second diffracting section 32 of the diffraction element 17D is adapted to diffract a laser beam of the second wavelength but substantially transmit a laser beam of the first wavelength and a laser beam of the third wavelength. Thus, the second diffracting section 32 operates as controlling diffracting section for controlling the extent of diffraction as a function of the wavelength of the incident laser beam.

Unlike the first diffracting section 31, the second diffracting section 32 is not formed by bonding members to be bonded but can be made to be adapted to diffract a laser beam of the second wavelength but substantially transmit a laser beam of the first wavelength and a laser beam of the third wavelength by adjusting the depth and the width of the steps 34a through 34d. In other words, it is formed by bonding an air layer that shows a refractive index equal to 1.

However, alternatively, the second diffracting section 32 may be formed by bonding members to be bonded that show respective refractive indexes with different frequency characteristics. When the second diffracting section 32 is formed by bonding members to be bonded that show respective refractive indexes with different frequency characteristics, it is possible to make it diffract a laser beam of the third wavelength but substantially transmits a laser beam of the first wavelength and a laser beam of the second wavelength. Thus, it is possible to raise the degree of design freedom without making the configuration of the pickup a complex one.

The objective lens 18 is used when the disc-shaped recording medium 100 on which information signals are recorded and from which information signals are reproduced by means of a laser beam of the third wavelength is an optical disc 100c of the third type, whereas the objective lens 18A is used when the disc-shaped recording medium 100 is an optical disc 100d of the fourth type.

As a laser beam of the first wavelength is emitted from the first light emitting element 9a of the first light source 9 of the optical pickup 6D having the above described configuration, it is made to enter the diffraction element 17D by way of the light path similar to that of the above described optical pickups. The laser beam that enters the diffraction element 17D is diffracted by the first diffracting section 31 but substantially transmitted through the second diffracting section 32 and made to enter the objective lens 18 or the objective lens 18A so that it is focused onto the recording surface of the optical disc 100a of the first type that is mounted on the disc table 3 to record information signals on or reproduce information signals from the optical disc 100a of the first type. The light path of the return light reflected by the recording surface of the optical disc 100a of the first type is same as that of any of the above described optical pickups and hence will not be described here any further.

Similarly, a laser beam of the second wavelength is emitted from the second light emitting element 9b of the first light source 9, it is made to enter the diffraction element 17D by way of the light path similar to that of the above described optical pickups. The laser beam that enters the diffraction element 17D is substantially transmitted through the first diffracting section 31 but diffracted by the second diffracting section 32 and made to enter the objective lens 18 or the objective lens 18A so that it is focused onto the recording surface of the optical disc 100b of the second type that is mounted on the disc table 3 to record information signals on or reproduce information signals from the optical disc 100b of the second type. The light path of the return light reflected by the recording surface of the optical disc 100b of the second type is same as that of any of the above described optical pickups and hence will not be described here any further.

On the other hand, as a laser beam of the third wavelength is emitted from the third light emitting element 10a of the second light source 10 of the optical pickup 6D, it is made to enter the diffraction element 17D by way of the light path similar to that of the above described optical pickups and transmitted through the first diffracting section 31 and the second diffracting section 32 of the diffraction element 17D. Then, it is made to enter the objective lens 18 or the objective lens 18A so that it is focused onto the recording surface of the optical disc 100c of the third type or the optical disc 100d of the fourth type that is mounted on the disc table 3 to record information signals on or reproduce information signals from the third optical disc 100c of the third type or the fourth optical disc 100d of the fourth type, whichever appropriate. The light path of the return light reflected by the recording surface of the optical disc 100c of the third type or that of the optical disc 100d of the fourth type is same as that of the above described optical pickups and hence will not be described here any further.

With the above-described arrangement of using an objective lens 18 having an annular band 18a for adjusting the aperture of the lens and a diffraction element 17D having a first diffracting section 31 that operates as first controlling diffracting section and a second diffracting section 32 that operates as second controlling diffracting section formed on the opposite surfaces thereof, it is possible to properly record information signals on and reproduce information signals from disc-shaped recording mediums 100 of the three different types including optical discs 100a, 100b, 100c of the first through third type by means of a single objective lens 18.

When the objective lens 18A is used and a first diffracting section 31 that operates as first controlling diffracting section and a second diffracting section 32 that operates as second controlling diffracting section are formed on the opposite surfaces of the diffraction element 17D, it is possible to properly record information signals on and reproduce information signals from disc-shaped recording mediums 100 of the three different types including optical discs 100a, 100b, 100d of the first, second and fourth types by means of a single objective lens 18A.

In this way, a laser beam of any of the three different wavelengths is focused on the recording surface of the optical disc of the corresponding type that is mounted on the disc table 3 by means of the single objective lens of the optical pickup 6D according to the present invention.

As either the first diffracting section 31 or the second diffracting section 32 is arranged to operate as controlling diffracting section and the laser beam of one of the first through third wavelengths or the laser beams of two of the first through third wavelengths are substantially transmitted through the controlling diffracting section in the optical pickup 6D according to the invention, it is possible to properly record information signals on and reproduce information signals from disc-shaped recording mediums of the three different types, which correspond respectively to laser beams of three different wavelengths, by means of the single objective lens.

Additionally, as information signals can be recorded on and reproduced from disc-shaped recording mediums of the three different types, which correspond respectively to laser beams of different wavelengths, by means of the single objective lens of the optical pickup 6D according to the invention, it is possible to reduce the number of components and hence both the dimensions of the optical pickup and the manufacturing cost. Furthermore, since the optical pickup 6D according to the invention is adapted to use a single objective lens, the weight of the movable part of objective lens drive unit is reduced to secure an excellent responsiveness of the movable part in the focusing control operation and the tracking control operation.

As the optical pickup 6D according to the invention includes diffracting sections 31, 32 formed respectively on the surface of incidence and the light emitting surface of the diffraction element 17D and one of the diffracting sections of the diffraction element 17D, or the diffracting section 31, is formed by bonding members to be bonded having different refractive indexes so as to make it operate as controlling diffracting section, it is possible to properly record information signals on and reproduce information signals from disc-shaped recording mediums of the three different types including optical discs 100a of the first type, optical discs 100b of the second type, optical discs 100c of the third type or optical discs 100d of the fourth type by means of the single objective lens of the optical pickup 6D according to the invention.

As holograms are formed in the controlling diffracting sections of the optical pickup 6D according to the invention and made to show a profile like that of staircases having five steps, it is possible to provide diffracting sections showing a desired diffraction efficiency.

As the optical pickup 6D according to the invention includes diffracting sections 31, 32 formed respectively on the surface of incidence and the light emitting surface of the diffraction element 17D and one of the diffracting sections of the diffraction element 17D, or the diffracting section 31, is made to operate as first controlling diffracting section, while the other diffracting section, or the diffracting section 32, is made to operate as second controlling diffracting section so that the first controlling diffracting section diffracts a laser beam of the first wavelength but transmits a laser beam of the second wavelength and a laser beam of the third wavelength and the second controlling diffracting section diffracts a laser beam of the second wavelength but transmits a laser beam of the first wavelength and a laser beam of the third wavelength, it is possible to properly record information signals on and reproduce information signals from disc-shaped recording mediums of the three different types including optical discs 100a of the first type, optical discs 100b of the second type, optical discs 100c of the third type or optical discs 100d of the fourth type by means of the single objective lens of the optical pickup 6D according to the invention.

As the optical pickup 6D according to the invention includes diffracting sections 31, 32 formed respectively on the surface of incidence and the light emitting surface of the diffraction element 17D and one of the diffracting sections of the diffraction element 17D, or the diffracting section 31, is formed as first controlling diffracting section by bonding members to be bonded that show different refractive indexes, while the other diffracting section of the diffraction element 17D, is formed as second controlling diffracting section by bonding members to be bonded that show different refractive indexes, it is possible to properly record information signals on and reproduce information signals from disc-shaped recording mediums of the three different types including optical discs 100a of the first type, optical discs 100b of the second type, optical discs 100c of the third type or optical discs 100d of the fourth type by means of the single objective lens of the optical pickup 6D according to the invention.

While the first through third light emitting elements 9a, 9b, 10a of the above described optical pickup 6D are arranged in the first light source 9 and the second light source 10, the optical pickup 6D may alternatively be provided with a single light source where the first light emitting element for emitting a laser beam of the first wavelength, the second light emitting element for emitting a laser beam of the second wavelength and the third light emitting element for emitting a laser beam of the third wavelength are arranged so that information signals may be recorded on and reproduced from a disc-shaped recording medium of any of the three different types by means of a laser beam of the corresponding wavelength emitted from the single light source section, the above described diffraction element 17D and the above-described objective lens.

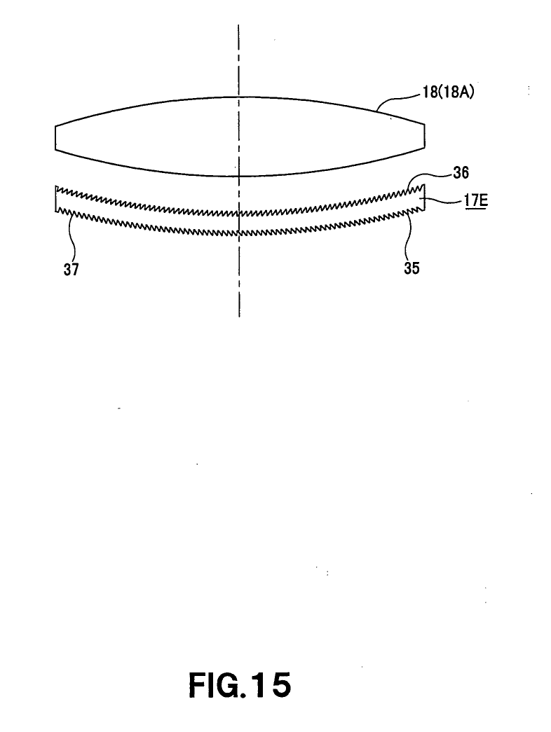

The above-described optical pickup 6D including diffracting sections where holograms showing a staircase-like profile are arranged may be replaced by an optical pickup 6E including first and second diffracting sections and an anti-stray-light section as illustrated in FIG 15.

Now, the optical pickup 6E including an anti-stray-light section will be described below. The optical pickup 6E having an anti-stray-light section differs from the above described optical pickup 6D having holograms that show a staircase-like profile only in terms of the configuration of the diffraction element and that of the objective lens. In the following description, the components that are common to the optical pickup 6E and the above described optical pickup 6D are denoted respectively by the same reference symbols and will not be described any further.

As shown in FIGS. 10 and 15, the optical pickup 6E typically includes a first light source 9, a second light source 10, a coupling lens 11, a light path synthesizing element 12, a beam splitter 13, a collimator lens 14, an upturn mirror 15, a ¼ wave plate 16, a diffraction element 17E, an objective lens 18 (18A), a conversion lens 19, an optical axis synthesizing element 20 and a light receiving element 21, all of which are arranged on the movable base 7 except the objective lens 18 (18A) that is arranged in the movable section 8a of the objective lens drive unit 8.

As shown in FIGS. 15, the diffraction element 17E has a first diffracting section 35 and a second diffracting section 36 arranged respectively on the opposite surfaces thereof. The diffraction element 17E additionally has an anti-stray-light section 37 that is formed in the region of the surface thereof located vis-a-vis the upturn mirror 15 (the surface of incidence) where the first diffracting section 35 is arranged other than the region occupied by the hologram. The anti-stray-light section 37 may typically be produced by forming a convex surface having a large radius of curvature at the light receiving side of the diffraction element 17E. In other words, as a convex surface having a large radius of curvature is formed, the region of one of the surfaces of the diffraction element 17E other than the region occupied by the hologram operates as anti-stray-light section 37. A convex surface may also be formed on the light emitting side of the diffraction element 17E so as to make it show a profile corresponding to that of the light receiving side.

Holograms are formed respectively in the first diffracting section 35 and the second diffracting section 36 of the diffraction element 17E like those of the first and second diffracting sections 31, 32 of the above described diffraction element 17D. Note, however, that holograms are formed in the above described diffraction element 17D by using planar surfaces as reference surfaces whereas holograms are formed in the diffraction element 17E by using convex surfaces as reference surfaces. The holograms show a profile like that of staircases having five steps including the first through fourth steps of a substantially same depth. In other words, the holograms have respective diffraction surfaces including the first through fifth diffraction surfaces that are arranged at regular intervals. While the number of steps of the staircase-like profile that defines the number of diffraction surfaces is five in this embodiment, the number of steps is by no means limited to five. Additionally, while the first diffracting section 35 is formed by bonding different members to be bonded that show respective refractive indexes whose frequency characteristics are different from each other and the second diffracting section 36 is exposed to air, the arrangement of the first and second diffracting sections is by no means limited thereto. Each of the first and second diffracting sections may be formed by bonding different members to be bonded that show respective refractive indexes whose frequency characteristics are different from each other.

The anti-stray-light section 37 can effectively prevent problems such as a problem that incident light is reflected by a planar part other than a hologram of an element where the hologram is formed in part of an aperture thereof and reflected light enters the photoelectric transducer of a photo-detector, for example, as stray light to degrade the characteristics of the transducer.

As the anti-stray-light section 37 is made to show a curved profile as described above, the incoming laser beam of collimated light is reflected and diffused by it to reduce stray light and hence the adverse effect of stray light.

When first and second curved surfaces are formed respectively at the opposite sides of the diffraction element, the incoming laser beam of collimated light can be emitted as a laser beam of collimated light to prevent it from exerting any adverse effect on the downstream optical components where it passes. When the hologram is formed only in part of the aperture of the diffraction element, another hologram may be formed with a different profile or a different depth in a planar area not occupied by the former hologram.

The objective lens 18 is used when the disc-shaped recording medium 100 on which information signals are recorded and from which information signals are reproduced by means of a laser beam of the third wavelength is an optical disc 100c of the third type, whereas the objective lens 18A is used when the disc-shaped recording medium 100 is an optical disc 100d of the fourth type.

As a laser beam of the first wavelength is emitted from the first light emitting element 9a of the first light source 9 of the optical pickup 6E having the above described configuration, it is made to enter the diffraction element 17D by way of the light path similar to that of the above described optical pickups. The laser beam that enters the diffraction element 17D is diffracted by the first diffracting section 35 but substantially transmitted through the second diffracting section 36 and made to enter the objective lens 18 or the objective lens 18A so that it is focused onto the recording surface of the optical disc 100a of the first type that is mounted on the disc table 3 to record information signals on or reproduce information signals from the optical disc 100a of the first type. The light path of the return light reflected by the recording surface of the optical disc 100a of the first type is same as that of any of the above described optical pickups and hence will not be described here any further.

Similarly, a laser beam of the second wavelength is emitted from the second light emitting element 9b of the first light source 9, it is made to enter the diffraction element 17D by way of the light path similar to that of the above described optical pickups. The laser beam that enters the diffraction element 17D is substantially transmitted through the first diffracting section 35 but diffracted by the second diffracting section 36 and made to enter the objective lens 18 or the objective lens 18A so that it is focused onto the recording surface of the optical disc 100b of the second type that is mounted on the disc table 3 to record information signals on or reproduce information signals from the optical disc 100b of the second type. The light path of the return light reflected by the recording surface of the optical disc 100b of the second type is same as that of any of the above described optical pickups and hence will not be described here any further.

On the other hand, as a laser beam of the third wavelength is emitted from the third light emitting element 10a of the second light source 10, it is made to enter the diffraction element 17D by way of the light path similar to that of the above-described optical pickups and transmitted through the first diffracting section 35 and the second diffracting section 36 of the diffraction element 17D. Then,.it is made to enter the objective lens 18 or the objective lens 18A so that it is focused onto the recording surface of the optical disc 100c of the third type or the optical disc 100d of the fourth type that is mounted on the disc table 3 to record information signals on or reproduce information signals from the optical disc 100c of the third type or the optical disc 100d of the fourth type, whichever appropriate. The light path of the return light reflected by the recording surface of the optical disc 100c of the third type or that of the optical disc 100d of the fourth type is same as that of the above described optical pickups and hence will not be described here any further.

Regardless of the light emitting element that is selected out of the first through third light emitting elements 9a, 9b, 10a to emit a laser beam, the anti-stray-light section 37 of the diffraction element 17E diffuses the laser beam that enters the diffraction element 17D in the region other than the hologram on the forward route thereof due to the curved profile of the anti-stray-light section 37 so that it can effectively prevent so called stray light from taking place when the reflected laser beam enters the light receiving element 21.

With the above described arrangement of using an objective lens 18 having an annular band 18a for adjusting the aperture of the lens and a diffraction element 17E having a first diffracting section 35 that operates as first controlling diffracting section and a second diffracting section 36 that operates as second controlling diffracting section formed on the opposite'surfaces thereof, it is possible to properly record information signals on and reproduce information signals from disc-shaped recording mediums 100 of the three different types including optical discs 100a, 100b, 100c of the first through third type by means of a single objective lens 18.

When the objective lens 18A is used and having a first diffracting section 35 that operates as first controlling diffracting section and a second diffracting section 36 that operates as second controlling diffracting section are formed on the opposite surfaces of the diffraction element 17E, it is possible to properly record information signals on and reproduce information signals from disc-shaped recording mediums 100 of the three different types including optical discs 100a, 100b, 100d of the first, second and fourth types by means of a single objective lens 18A.

In this way, a laser beam of any of the three different wavelengths is focused on the recording surface of the optical disc of the corresponding type that is mounted on the disc table 3 by means of the single objective lens of the optical pickup 6E according to the present invention.

As either the first diffracting section 35 or the second diffracting section 36 is arranged to operate as controlling diffracting section and the laser beam of one of the first through third wavelengths or the laser beams of two of the first through third wavelengths are substantially transmitted through the controlling diffracting section in the optical pickup 6E according to the invention, it is possible to properly record information signals on and reproduce information signals from disc-shaped recording mediums of the three different types, which correspond respectively to laser beams of three different wavelengths, by means of the single objective lens and prevent degradation of characteristics due to stray light from taking place by preventing stray light.

Additionally, as information signals can be recorded on and reproduced from disc-shaped recording mediums of the three different types, which correspond respectively to laser beams of different wavelengths, by means of the single objective lens of the optical pickup 6E according to the invention, it is possible to reduce the number of components and hence both the dimensions of the optical pickup and the manufacturing cost. Furthermore, since the optical pickup 6E according to the invention is adapted to use a single objective lens, the weight of the movable part of objective lens drive unit is reduced to secure an excellent responsiveness of the movable part in the focusing control operation and the tracking control operation.

Thus, as described above in detail, a disc drive apparatus 1 according to the invention can record information signals to and reproduce information signals from disc-shaped recording mediums 100 of three different types to be used with laser beams of different wavelengths by means of a single objective lens 18, 18A or 18B so that it can be produced with a reduced number of components to make it possible to reduce both the dimensions of the disc drive apparatus 1 and the manufacturing cost.

Furthermore, since a disc drive apparatus 1 according to the invention is adapted to use a single objective lens 18, 18A or 18B, the weight of the movable part 8a of objective lens drive unit 8 is reduced to secure an excellent responsiveness of the movable part 8a in the focusing control operation and the tracking control operation.

Still additionally, a disc drive apparatus 1 according to the invention includes a disc table for receiving a disc-shaped recording medium of one of different types and driving it to rotate and an optical pickup 6, 6A, 6B, 6C, 6D or 6E for recording information to or reproducing information from the disc-shaped recording medium received on the disc table and, in the optical pickup, either the first or second diffracting section is adapted to substantially transmit one or two of the laser beams of the first through third wavelengths so that it is possible to record information signals to and reproduce information signals from disc-shaped recording mediums of three different types to be used with laser beams of different wavelengths by means of a single objective lens.

Still additionally, a disc drive apparatus 1 according to the invention can record information signals to and reproduce information signals from disc-shaped recording mediums of three different types to be used with laser beams of different wavelengths by means of a single objective lens so that it can be produced with a reduced number of components to make it possible to reduce both the dimensions of the disc drive apparatus and the manufacturing cost. Furthermore, since a disc drive apparatus 1 according to the invention is adapted to use a single objective lens, the weight of the movable part of objective lens drive unit is reduced to secure an excellent responsiveness of the movable part in the focusing control operation and the tracking control operation.

Still additionally, a disc drive apparatus 1 according to the invention includes an annular band formed on the objective lens to adjust the aperture of the objective lens and diffracting sections formed respectively on the surface of incidence and the light emitting surface of the diffraction element, one of the diffracting sections of the diffraction element being adapted to operate as controlling diffracting section so that it is possible to properly record information signals on and reproduce information signals from disc-shaped recording mediums of the three different types including optical discs 100a of the first type, optical discs 100b of the second type, optical discs 100c of the third type by means of the single objective lens.

Alternatively, a disc drive apparatus 1 according to the invention includes diffracting sections formed respectively on one of the opposite surfaces of the objective lens and on one of the opposite surfaces of the diffraction element and the diffracting section of the diffraction element is made to operate as controlling diffracting section so that it is possible to properly record information signals on and reproduce information signals from disc-shaped recording mediums of the three different types including optical discs 100a of the first type, optical discs 100b of the second type, optical discs 100d of the fourth type by means of the single objective lens.

Still additionally, in a disc drive apparatus 1 according to the invention, the controlling diffracting section is formed by bonding materials that perform differently for dispersion of light so that it is possible to form a diffracting section that shows a desired diffraction efficiency by selecting an optimal combination of materials to be bonded together that differ from each other in terms of dispersion characteristics.

Furthermore, a disc drive apparatus 1 according to the invention may include a polarization hologram element as the diffraction element that is realized by forming diffracting sections respectively on the surface of incidence and on the light emitting surface thereof in such a way that laser beams whose senses of polarization are orthogonal relative to each other can be made to enter the polarization hologram element and the diffracting section of the polarization hologram element is made to operate as the controlling diffracting section so that it is possible to record information signals on and reproduce information signals from disc-shaped recording mediums of the three different types by means of the single objective lens with a simple configuration.

While the present invention is described above by way of the best modes of carrying out the invention in terms of the profile and the structure of each component, the present invention is by no means limited thereto and the above described embodiments do not limit the technological scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup comprising:
a first light emitting element that emits a laser beam of a first wavelength;
a second light emitting element that emits a laser beam of a second wavelength;
a third light emitting element that emits a laser beam of a third wavelength;
an objective lens that focuses the laser beams emitted from the first through third light emitting elements onto the signal recording surface of a disc-shaped recording medium;
first and second diffracting sections arranged on the light paths of the first through third laser beams and adapted to diffract at least one of the laser beams of the first through third wavelengths; and
a light receiving element that receives the return light reflected by the disc-shaped recording medium;
the first diffracting section being adapted to substantially transmit one or two of the laser beams of the first through third wavelengths.

2. The optical pickup according to claim 1, wherein
the first wavelength is about 780 nm,
the second wavelength is about 660 nm, and
the third wavelength is about 405 nm.

3. The optical pickup according to claim 1, wherein the first diffracting section is formed by bonding materials with respective refractive indexes showing different frequency characteristics.

4. The optical pickup according to claim 1 or 3, further comprising:
a diffraction element arranged on the light path of the first through third laser beams, wherein
an annular band for adjusting the aperture is formed on the objective lens,
the first diffracting section is formed on either the surface of incidence or the light emitting surface of the diffraction element, and
the second diffracting section is formed on the other surface of the diffraction element.

5. The optical pickup according to claim 1 or 3, further comprising:
a diffraction element arranged on the light path of the first through third laser beams, wherein
the first diffracting section is formed on one of the surfaces of the diffraction element, and
the second diffracting section is formed on one of the surfaces of the objective lens.

6. The optical pickup according to claim 1 or 3, further comprising:
a diffraction element arranged on the light path of the first through third laser beams, wherein
the first diffracting section is formed on either the surface of incidence or the light emitting surface of the diffraction element, and
the second diffracting section is formed on the other surface of the diffraction element.

7. The optical pickup according to claim 6, wherein
the first diffracting section diffracts a laser beam of the first wavelength and transmits a laser beam of the second wavelength and a laser beam of the third wavelength, and
the second diffracting section diffracts a laser beam of the second wavelength and transmits a laser beam of the first wavelength and a laser beam of the third wavelength.

8. The optical pickup according to claim 6, wherein a hologram is formed in the first diffracting section and the hologram shows a profile like that of a staircase having first through fourth steps.

9. The optical pickup according to claim 6, wherein a hologram is formed in the first diffracting section and the hologram shows a staircase-like profile and has diffraction planes including the first through fifth diffraction planes that are arranged at regular intervals.

10. The optical pickup according to claim 1, further comprising:
a diffraction element arranged on the light path of the first through third laser beams, wherein
the first diffracting section is formed on either the surface of incidence or the light emitting surface of the diffraction element,
the second diffracting section is formed on the other surface of the diffraction element, and
each of the first and second diffracting sections is formed by bonding materials with respective refractive indexes showing different frequency characteristics.

11. The optical pickup according to claim 10, wherein a hologram is formed in each of the first and second diffracting sections and the holograms show a profile like that of a staircase having first through fourth steps.

12. The optical pickup according to claim 10, wherein a hologram is formed in each of the first and second diffracting sections and the holograms show staircase-like profile and have diffraction planes including the first through fifth diffraction planes that are arranged at regular intervals.

13. The optical pickup according to claim 1 or 3, further comprising:
a polarization hologram element arranged on the light path of the first through third laser beams, wherein
the first and second diffracting sections are formed respectively on the surface of incidence and on the light emitting surface of the polarization hologram element, and
laser beams with senses of polarization orthogonal relative to each other are made to enter the polarization hologram element.

14. A disc drive apparatus including
a disc table that receives a disc-shaped recording medium of one of different types and drives it to rotate, and
an optical pickup that records information to or reproduces information from the disc-shaped recording medium received on the disc table,
the optical pickup comprising:
a first light emitting element that emits a laser beam of a first wavelength;
a second light emitting element that emits a laser beam of a second wavelength;
a third light emitting element that emits a laser beam of a third wavelength;
an objective lens that focuses the laser beams emitted from the first through third light emitting elements onto the signal recording surface of a disc-shaped recording medium;
first and second diffracting sections arranged on the light paths of the first through third laser beams and adapted to diffract at least one of the laser beams of the first through third wavelengths; and
a light receiving element that receives the return light reflected by the disc-shaped recording medium;
the first diffracting section being adapted to substantially transmit one or two of the laser beams of the first through third wavelengths.

15. A disc drive apparatus including
a disc table that receives a disc-shaped recording medium of one of different types and drives it to rotate, and
an optical pickup that records information to or reproduces information from the disc-shaped recording medium received on the disc table,
the optical pickup comprising:
a first light emitting element that emits a laser beam of a first wavelength;
a second light emitting element that emits a laser beam of a second wavelength;
a third light emitting element that emits a laser beam of a third wavelength, an objective lens that focuses the laser beams emitted from the first through third light emitting elements onto the signal recording surface of a disc-shaped recording medium;
first and second diffracting sections arranged on the light paths of the first through third laser beams and adapted to diffract at least one of the laser beams of the first through third wavelengths; and
a light receiving element that receives the return light reflected by the disc-shaped recording medium;
the first diffracting section being formed by bonding materials with respective refractive indexes showing different frequency characteristics, and
the first diffracting section being adapted to substantially transmit one or two of the laser beams of the first through third wavelengths.

16. A disc drive apparatus including
a disc table that receives a disc-shaped recording medium of one of different types and drives it to rotate, and
an optical pickup that records information to or reproduces information from the disc-shaped recording medium received on the disc table,
the optical pickup comprising:
a first light emitting element that emits a laser beam of a first wavelength;
a second light emitting element that emits a laser beam of a second wavelength;
a third light emitting element that emits a laser beam of a third wavelength;
an objective lens that focuses the laser beams emitted from the first through third light emitting elements onto the signal recording surface of a disc-shaped recording medium;
first and second diffracting sections arranged on the light paths of the first through third laser beams and adapted to diffract at least one of the laser beams of the first through third wavelengths;
a light receiving element that receives the return light reflected by the disc-shaped recording medium; and
a diffraction element arranged on the light path of the first through third laser beams;
the first diffracting section being formed on either the surface of incidence or the light emitting surface of the diffraction element,
the second diffracting section being formed on the other surface of the diffraction element,
the first diffracting section being formed by bonding materials with respective refractive indexes showing different frequency characteristics, and
the first diffracting section being adapted to substantially transmit one or two of the laser beams of the first through third wavelengths.
